(19) United States
(12) Patent Application Publication
(10) Pub. No.: US 2014/0000428 A1
(43) Pub. Date: Jan. 2, 2014

(54) Self-Lubricating Saw Blade Assembly with Debris Removal Paths

(71) Applicants: Paul G. Cairns, Houston, TX (US); Brian Breaux, Houston, TX (US); Brian Ross, Houston, TX (US)

(72) Inventors: Paul G. Cairns, Houston, TX (US); Brian Breaux, Houston, TX (US); Brian Ross, Houston, TX (US)

(73) Assignee: Baker Hughes Incorporated, Houston, TX (US)

(21) Appl. No.: 13/537,586

(22) Filed: Jun. 29, 2012

(51) Int. Cl. B26D 7/08; B23D 61/02; E21B 29/00; B26D 1/14

(52) U.S. Cl. 83/14; 83/169; 83/167; 83/109

(57) ABSTRACT

A self-lubricating circular saw blade assembly and method of use. A circular saw blade assembly includes a circular saw blade having a cutting edge and axial sides. A lubricant disc is disposed upon at least one axial side. The lubricant disc provides lubrication to an area being cut during operation and provides debris removal.

### BACKGROUND OF THE INVENTION

1. Field of the Invention

The invention relates generally to the design of circular saw blades. In particular aspects, the invention relates to the design of saw blades used in mechanical pipe cutting tools.

2. Description of the Related Art

Circular saws are used in a wide variety of applications. Circular saw blades are used, for example, in pipe cutting tools, such as the Mechanical Pipe Cutter™ (MPC™) electromechanical pipe-cutting tool which is available commercially from Baker Hughes Incorporated of Houston, Tex. These devices cut a pipe from the inside. During operation, the saw blade is moved in a circular or an eccentric manner to cut through the pipe.

Lubrication and cutting debris traditionally present operational problems for such cutting tools. Maintaining consistent lubrication at the cutting surface of the blade can be difficult. In the instance of a pipe cutter, for example, the blade may have to be used downhole at great depth or even in a deviated wellbore, making delivery of a desired amount of lubricant difficult. Cutting debris can bind a cutting blade and impede the efficiency of the cutting process.

### SUMMARY OF THE INVENTION

The invention provides an innovative design for a self-lubricating saw blade assembly that is useful in a circular saw apparatus. An exemplary saw blade assembly is described that incorporates a circular saw cutting blade with one or more associated lubricant discs. In a described embodiment, a single cutting blade is associated with two lubricant discs that are placed located on either axial side of the cutting blade. Also in a described embodiment, the lubricant discs are bonded to the cutting blade.

In described embodiments, the one or more lubricant discs are formed of a rigid material that can be readily abraded and impregnated with a lubricant. In a particular embodiment, the discs are formed of porous PEEK (polyether ether ketone). The lubricant disc may also be non-rigid, absorbent, easily abraded and can be bonded to the cutting blade. Where the lubricant disc is non-rigid, the cutting blade will provide the rigidity for the saw blade assembly. Other embodiments can include one or more lubricating discs and one or more saw blades. The lubricant discs may be bonded to the cutting blade or, alternatively, they may be mechanically coupled to the cutting blade by means of the arbor shaft and a locking nut. Also in particular embodiments, the lubricant discs are provided with debris removal slots that extend radially outwardly from a hub portion that surrounds the center of the disc.

In operation, a circular saw blade assembly constructed in accordance with the present invention is placed into a circular saw tool, and the circular saw tool is operated to rotate the saw blade assembly and bring it into cutting contact with a workpiece being cut. The blade makes an initial cut into the workpiece, and as the blade penetrates deeper into the workpiece, the one or more lubricant discs are brought into contact with the workpiece and apply lubricant proximate the cut being made as the saw blade assembly is rotated. The edges of the one or more lubricant discs will also abrade and erode as the cutting operation continues, permitting the cut to be made deeper into the workpiece while additional lubricant is secreted and applied. In addition, cutting debris created by the saw blade assembly will be received into the debris removal slots of the one or more lubricant discs, thereby removing the debris from the cutting area.

### BRIEF DESCRIPTION OF THE DRAWINGS

The advantages and further aspects of the invention will be readily appreciated by those of ordinary skill in the art as the same becomes better understood by reference to the following detailed description when considered in conjunction with the accompanying drawings in which like reference characters designate like or similar elements throughout the several figures of the drawing and wherein:

FIG. 1 is a side view of an exemplary circular saw blade assembly constructed in accordance with the present invention.

FIG. 2 is a cross-sectional view of the saw blade assembly shown in FIG. 1 taken along lines 2-2.

FIG. 3 is an isometric view of a downhole mechanical pipe cutter device that incorporates the saw blade assembly of FIGS. 1 and 2.

FIG. 4 is a schematic view of an exemplary circular saw blade assembly in accordance with the present invention being used to cut a workpiece.

FIG. 5 is a schematic view of the exemplary circular saw blade assembly now at a further stage of cutting.

FIG. 6 is a schematic view of an exemplary circular saw blade assembly constructed in accordance with the present invention, wherein the lubricant blades of the assembly are being mechanically coupled to the saw blade.

### DETAILED DESCRIPTION OF THE PREFERRED EMBODIMENTS

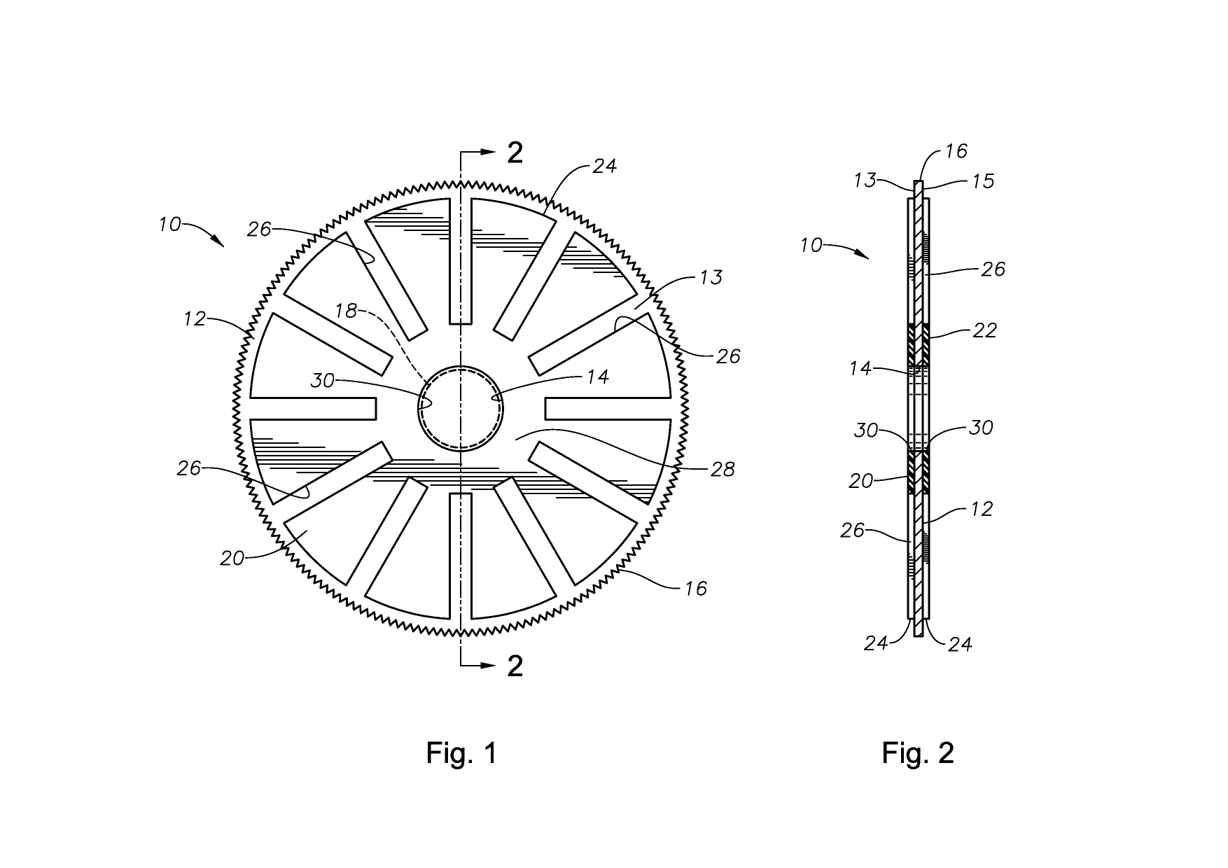

FIGS. 1 and 2 illustrate an exemplary self-lubricating circular saw blade assembly 10 that has been constructed in accordance with the present invention. The saw blade assembly 10 includes a circular blade 12 having a central opening 14 and a circumferential edge 16 for cutting. The cutting edge 16 may be toothed or serrated, as desired. An arbor shaft (shown in phantom at 18 in FIG. 1) passes through the opening 14 and is used to rotate the blade 12 of the blade assembly 10. The blade 12 has axial sides 13, 15.

A generally circular lubricant disc 20, 22 is disposed upon each axial side 13, 15 of the blade 12. The discs 20, 22 are preferably affixed to the blade 12 by bonding using a suitable adhesive. Alternatively, the discs 20, 22 are not secured with adhesive to the blade 12 but are instead, mechanically coupled to the blade 12 by the arbor shaft 18 and associated compression fittings, such as a locking nut 23 (see FIG. 6). In one embodiment, only a single lubricant disc is affixed to one axial side of the blade 12. The lubricant discs 20, 22 are formed of a material that can be impregnated with a lubricant or that will function to apply lubricant to a location being cut during operation. As will be described shortly, the lubricant discs 20, 22 are designed to provide lubrication in the area proximate a cut when the saw blade assembly 10 is being used to cut a workpiece. Also in particular embodiments, the lubricant discs 20, 22 are formed of a material that will readily erode or abrade away as the saw blade assembly is used to cut a workpiece. In a particular embodiment, the lubricant discs 20, 22 are formed of porous PEEK (polyether ether ketone) and are impregnated with a lubricant such as tungrease or another silicon-based grease or with machining oil. The lubricant is retained within the pores of the discs 20, 22, and as the discs 20, 22 are worn away, the lubricant is released and applied to the area proximate the cut being made.

The lubricant discs 20, 22 each have an outer circumferential edge 24. It is noted that the diameter of the lubricant discs 20, 22 are less than the diameter of the blade 12, and the outer circumference of the lubricant discs 20, 22 are preferably less than the outer circumference provided by the cutting edge 16 of the saw blade 12 to allow a cut to be started before lubrication is applied. In certain embodiments the lubricant discs 20, 22 are provided with debris removal slots 26 that extend from the outer circumference 24 to a central hub 28. Each lubricant disc 20, 22 has a central opening 30 formed within the center of the hub 28. The central openings 30 are aligned with the central opening 14 of the saw blade 12.

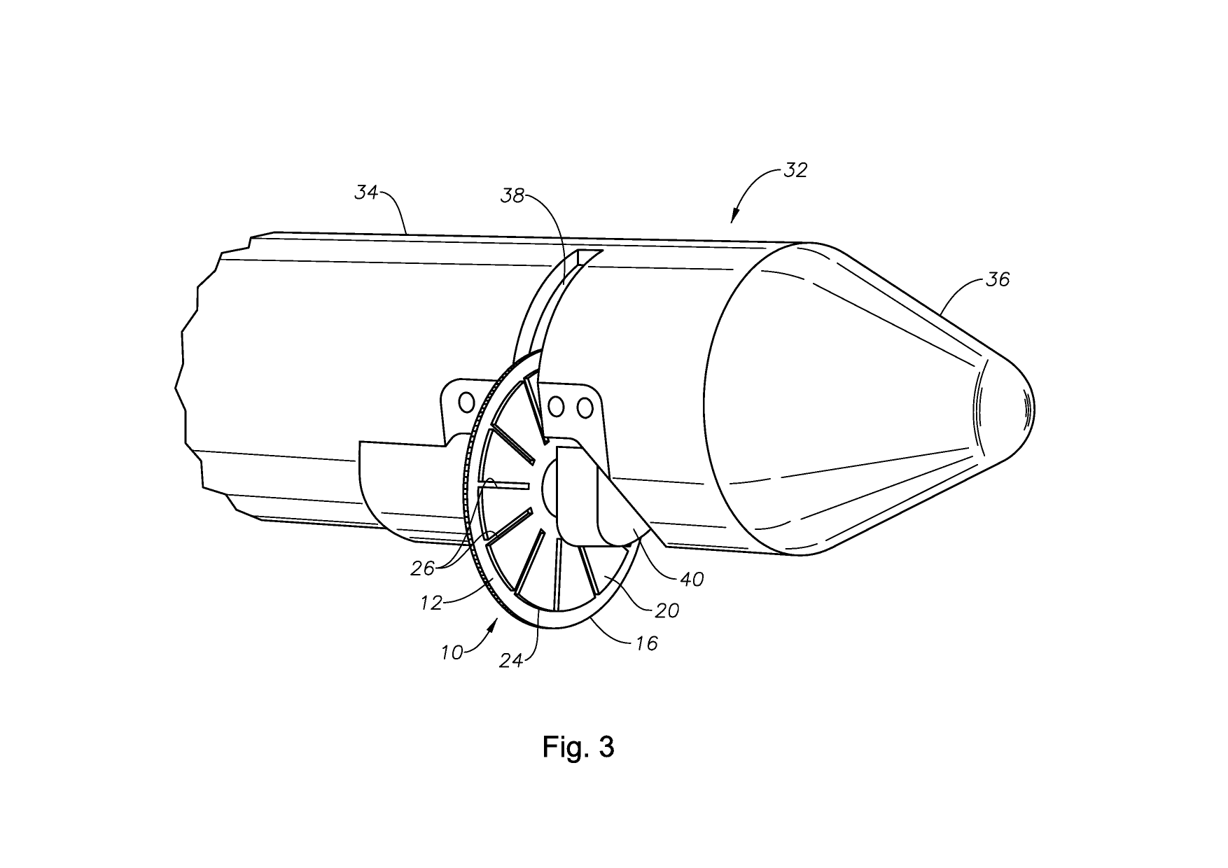

FIG. 3 illustrates the saw blade assembly 10 having been incorporated into an exemplary mechanical pipe cutter-style cutting tool 32. The tool 32 may be a Mechanical Pipe Cutter™ (MPC™) electromechanical pipe-cutting tool which is available commercially from Baker Hughes Incorporated of Houston, Tex. The cutting tool 32 includes a central carrier 34 with a tapered nose 36 which are typically run into a pipe to be cut. A slot 38 in the carrier 34 allows the blade assembly 10 to be moved radially out of the carrier 34 on arm 40. The blade assembly 10 is rotated about a central pivot (not shown) on the arm 40. During operation, the carrier 34 is typically rotated within a surrounding pipe to allow the entire interior circumference of a surrounding pipe to be cut with the blade assembly 10.

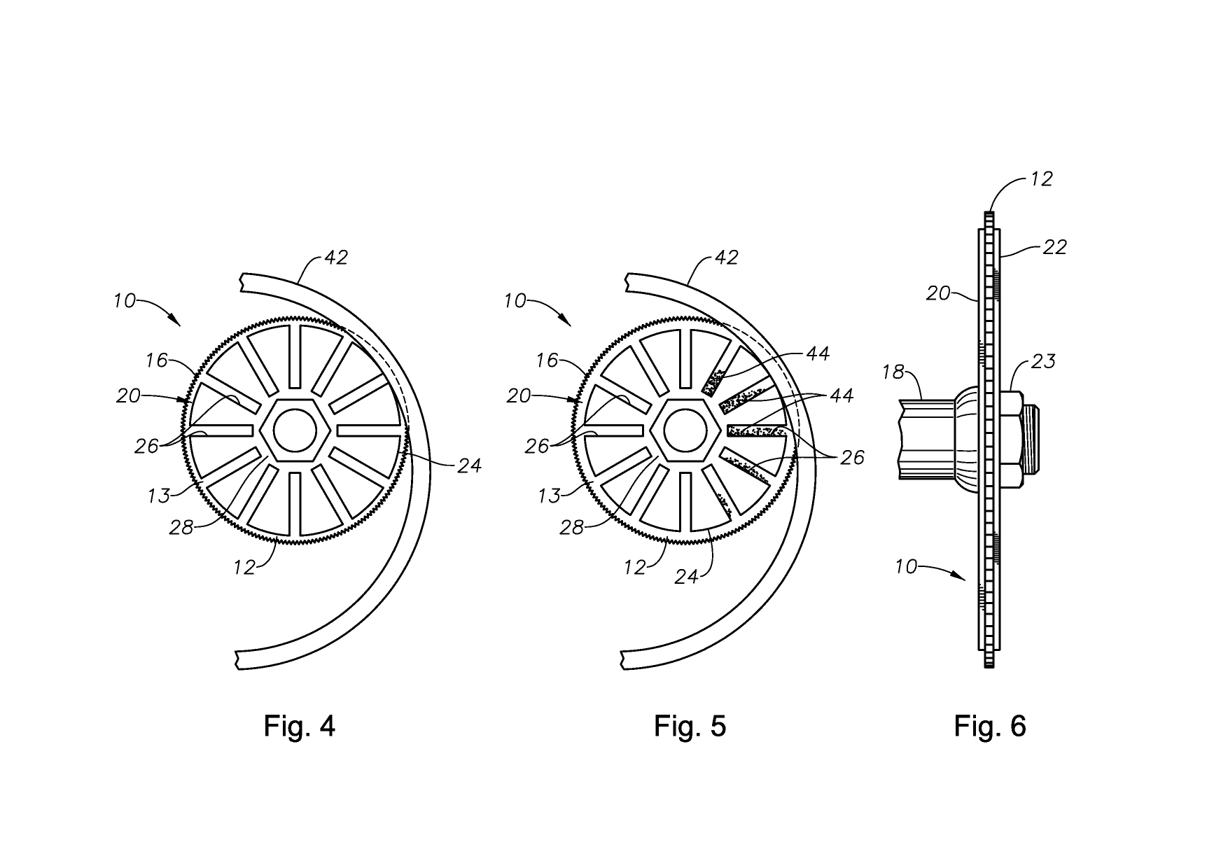

FIGS. 4 and 5 schematically illustrate an exemplary cutting process using a saw blade assembly 10 constructed in accordance with the present invention. In FIG. 4, the saw blade assembly 10 has begun a cut into a workpiece 42. The workpiece 42 in this instance is a pipe that is being cut from the radial interior. The cutting edge 16 of the blade 12 has begun a cut into the workpiece 42 and the edges 24 of the lubricant discs 20, 22 (only 20 visible in FIG. 4) is now in contact with the workpiece 42. The edges 24 of the discs 20, 22 apply lubricant to the workpiece 42 proximate the cut being made by the blade 12.

As the cutting process continues, the edges 24 of the discs 20, 22 will begin to erode or abrade away. In addition, cutting debris 44 created by the cutting process will be captured and accumulated within the debris removal slots 26, as FIG. 5 illustrates. The debris 44 might either remain within the slots 26 or be desirably flung out of or removed from the slots 26 away from the area of the cut under centrifugal force imparted by the rotation of the blade assembly 10. It is also noted with respect to FIG. 5, that the edges 24 of the discs 20, 22 are eroded or abraded away during use.

The invention has been described herein using an exemplary saw blade assembly 10 having a single saw blade 12 and two lubricant discs 20, 22. Those of skill in the art will understand that variations of the invention can be made using the principles described herein. For example, multi-layer blade assemblies can be formed of a plurality of cutting blades and lubricant discs arranged in a sandwich structure. Also, a given saw blade assembly might include discs within the sandwich structure having other compositions and functions. For example, a disc might have a brush edge that is used to help brush debris away from the cut being made. Other discs might serve a reinforcing function.

The foregoing description is directed to particular embodiments of the present invention for the purpose of illustration and explanation. It will be apparent, however, to one skilled in the art that many modifications and changes to the embodiment set forth above are possible without departing from the scope and the spirit of the invention.

What is claimed is:

1. A circular saw blade assembly comprising:
a circular saw blade having a circumferential cutting edge, a diameter and two axial sides; and
a lubricant disc disposed upon at least one axial side.

2. The circular saw blade assembly of claim 1 wherein the lubricant disc is substantially formed of polyether ether ketone impregnated with a lubricant.

3. The circular saw blade assembly of claim 1 wherein a lubricant disc is disposed upon each of the two axial sides.

4. The circular saw blade assembly of claim 1 wherein:
the lubricant disc has a diameter; and
the diameter of the lubricant disc is smaller than the diameter of the saw blade.

5. The circular saw blade assembly of claim 1 further comprising a debris removal slot formed within the lubricant disc.

6. The circular saw blade assembly of claim 5 wherein the debris removal slot extends radially inwardly from an outer circumferential edge of the lubricant disc.

7. The circular saw blade assembly of claim 6 wherein there is a plurality of debris removal slots that are disposed at angularly spaced intervals about the lubricant disc.

8. The circular saw blade assembly of claim 1 wherein the lubricant disc is affixed to the saw blade by bonding.

9. The circular saw blade assembly of claim 1 wherein the lubricant disc is mechanically coupled to the saw blade.

10. The circular saw blade assembly of claim 5 wherein cutting debris is accumulated within the debris removal slot during cutting.

11. The circular saw blade assembly of claim 10 wherein the accumulated cutting debris is further removed from the slot under centrifugal force from rotation of the circular saw blade assembly.

12. A method of cutting a workpiece with a self-lubricating circular saw blade assembly, the method comprising the steps of:
providing a self-lubricating circular saw blade assembly having a circular saw blade with a circumferential cutting edge, a diameter and two axial sides, and a lubricant disc disposed upon at least one axial side;
cutting into the workpiece with the cutting edge of the circular saw blade assembly; and
the lubricant disc providing lubrication to the workpiece proximate the cutting location.

13. The method of claim 12 wherein the lubricant disc includes a debris removal slot extends radially inwardly from an outer circumferential edge of the lubricant disc and wherein:
cutting debris is captured within the debris removal slot during cutting into the workpiece.

14. The method of claim 12 wherein the lubricant disc has an outer circumferential edge and wherein the outer circumferential edge of the lubricant disc erodes away during cutting.
